(19) United States
(12) Patent Application Publication
(10) Pub. No.: US 2009/0031998 A1
(43) Pub. Date: Feb. 5, 2009

(54) Air super charger

(76) Inventor: Jeong-whan Kim, Seoul (KR)

Correspondence Address: THE WEBB LAW FIRM, P.C., 700 KOPPERS BUILDING, 436 SEVENTH AVENUE, PITTSBURGH, PA, 15219, US

(21) Appl. No.: 11/665,597

(22) PCT Filed: Jun. 9, 2005
(86) PCT No.: PCT/KR2005/001737

§ 371 Date: May 28, 2008

(30) Foreign Application Priority Data
Oct. 18, 2004 (KR) 20-2004-0029445

(51) Int. Cl. F02B 33/00

(52) U.S. Cl. 123/559.1

(57) ABSTRACT

Disclosed herein is an air supercharger for vehicle engines. The air supercharger includes a cylindrical housing. Support ribs extend from the inner circumference of the housing to the center thereof. A shaft support pipe is provided at a predetermined position on the support ribs. A locking surface is provided on an upper end of the inner circumference of the housing. A stationary blade body is inserted into the housing and held between the locking surface and a stop surface of the housing. The stationary blade body includes support rims, stationary blades, and elastic parts. A rotating shaft is installed in the shaft support pipe. A rotary blade body is inserted into the stationary blade body and coupled to the rotating shaft. The rotary blade body includes a blade support pipe and rotary blades. Locking rings are provided on upper and lower ends of an outer circumference of the housing.

### TECHNICAL FIELD

The present invention relates to an air supercharger which forces air to be fed into an engine room while forming vortices in the flow of air, after the air passes through an air cleaner of a vehicle.

An air supercharger creates vortices in air fed into a combustion chamber of an engine of a vehicle, thus increasing the density of air. Generally, the air supercharger is installed between an air cleaner and an intake manifold of the engine. When inflow air passes through the air supercharger, the air is fed into the combustion chamber while being rotated by a helical blade, thus increasing the density of supplied air. Technology relating to the air supercharger or an intake air swirling device is disclosed in U.S. Pat. No. 2,017,043, U.S. Pat. No. 3,887,907, Japanese Laid-Open Publication Sho. 58-13122, Korean U.M. Publication No. 76-1369, etc.

The construction and problems of the conventional air supercharger or intake air swirling device are clearly described in Korean Pat. No. 41142. In order to solve the problems and accomplish several advantages, U.S. Pat. No. 4,962,642 and Korean Pat. No. 41142 have been proposed. According to the patents, air swirling devices having the same condition as an air swirling device installed at an air cleaner are installed both near an inlet port of an intake manifold and near an outlet port of an exhaust manifold, so that fuel particles injected from a carburetor are sufficiently mixed with air. The mixture is rapidly and strongly supplied to a combustion chamber of an engine. Thereby, engine output is greatly improved due to combustion explosion, and a sensation of speed when pressing an accelerating pedal is strongly felt, so fuel economy with respect to a traveling distance is excellent. Further, fuel is not disposed on the inner wall of the intake manifold while passing through the intake manifold, thus preventing the loss of fuel. Furthermore, intake and exhaust interference due to the rotational inertia of fluid is reduced. A large amount of rotating fluid is uniformly supplied to each cylinder, thus reducing the vibration of the engine, and preventing undesirable abrasion in the engine, and preventing impurities, such as carbon, from being deposited on the inner wall of the cylinder. Consequently, the life-span of the engine is increased.

### BACKGROUND ART

The conventional air supercharger or air swirling device is constructed so that a guide plate for swirling intake air is fixed.

As such, if the guide plate is fixed, the guide plate merely serves to guide inflow air in a predetermined direction (the direction in which air is swirled). Thus, the air may be more efficiently mixed with mixture gas in the passage of an intake valve. However, air is sucked by the reciprocating motion of a piston, because a swirling operation does not contribute to the intake capacity. Hence, the air collides with a swirling device and is fed into a cylinder by air pressure, so that the pressure of the cylinder is not increased. When an equal amount of air passes through the swirling device, the flow rate of the air is increased at a position having a smaller sectional area due to the volume of the swirling device, but the flow rate of air after passing through the swirling device becomes equal to the flow rate of air before passing through the swirling device. Thus, it is problematic in that the amount of air fed into the cylinder is not increased.

In order to solve the problems of the conventional air supercharger or air swirling device, Korean Pat. Appln. No. 92-10868 has been proposed by the applicant of the present invention.

In the air supercharger which was previously filed with the KIPO, a rotary blade body is forcibly rotated using electricity which is applied to a power generating unit in the air supercharger, regardless whether and how the vehicle is driven, when the engine of the vehicle is started. Thus, the air supercharger has a forcible air intake function as well as an air swirling function, thus increasing the pressure of mixture gas in the cylinder. However, the air supercharger is problematic in that air is forcibly fed into the cylinder while being swirled, regardless of driving conditions, that is, regardless whether a vehicle is stopped, or is driven at low or high speed.

Further, in order to improve on the air supercharger, Korean U.M. Registration No. 87991 has been proposed by the applicant of this invention. According to the cited document, a cylindrical housing is installed between an air cleaner and an intake manifold, and a boss shaft is provided at a center of the housing, and a shaft of a rotary blade body and a rolling friction unit are installed on the boss shaft.

According to the previously registered utility model, since the amount of air passing through the intake manifold varies as the driving speed of a vehicle is increased or reduced, the rotary blade body installed in the housing collides with inflowing air, and is rotated by force generated by the collision. Thereby, air passing through the housing is swirled by the angle of the blade of the rotary blade body, prior to being supplied to a combustion chamber of an engine. It solves the problems of the conventional air supercharger or air swirling device to some extent. However, the air supercharger according to the utility model is problematic in that the intake capacity of the rotary blade body resulting from the collision with air depends only on the rotating force of the rotary blade body, so that it is insufficient to increase the amount of air which is taken in and swirled.

### DISCLOSURE OF INVENTION

### Technical Problem

Accordingly, the present invention has been made keeping in mind the above problems occurring in the prior art, and an object of the present invention is to provide an air supercharger, which is capable of increasing air swirling capacity, using the rotating force of a rotary blade body, which is generated by an amount of fed air varying according to the driving speed of a vehicle without an additional power supply, and a stationary blade body installed on the inner circumference of the housing.

Another object of the present invention is to provide an air supercharger, which allows a stationary blade body to be easily installed in a housing having a rotary blade body.

### Technical Solution

In order to accomplish the objects, the present invention provides an air supercharger for a vehicle engine, including a cylindrical housing installed between a manifold of the engine and an air cleaner, support ribs to extend from four sides of an inner circumference of the housing to a central position of the housing in such a way as to form a single structure, a shaft support pipe provided at a predetermined position on the support ribs, with a shaft hole being vertically formed in an axial direction of the housing, a locking surface provided on an upper end of the inner circumference of the housing and comprising an inclined step, with a concave notch being formed at a pre-determined position on the locking surface, a cylindrical stationary blade body inserted into the inner circumference of the housing and held between the locking surface and a stop surface of the housing, the stationary blade body comprising support rims provided on upper and lower ends of the stationary blade body, a stationary blade provided between the support rims and comprising a helical surface curved in a direction of an inner circumference of the stationary blade body, and an elastic part provided on the upper support rim and integrally provided with a locking protrusion, a rotating shaft installed in the shaft support pipe, together with a rolling frictional member, a rotary blade body inserted into the inner circumference of the stationary blade body and coupled to the rotating shaft, the rotary blade body including a blade support pipe coupled to the rotating shaft and covering the shaft support pipe and a rotary blade radially protruding from an outer surface of the blade support pipe and having a helical curved surface, and locking rings provided on upper and lower ends of an outer circumference of the housing and maintaining a stably installed state.

### ADVANTAGEOUS EFFECTS

As described above, the present invention allows a stationary blade body to be stably installed in a housing, allows an air supercharger to be stably installed between an air cleaner and an intake manifold, and causes a stationary blade and a guide surface to be formed at the same angle and in the same direction as those of a blade of a rotary blade body, thus rapidly thrusting swirling air into a combustion chamber of an engine, therefore improving fuel economy, and affording easy assembly and maintenance.

### BRIEF DESCRIPTION OF THE DRAWINGS

FIG. 1 is an exploded perspective view of an air supercharger, according to the present invention;

FIG. 2 is a vertical sectional view to show the assembled state of the air supercharger, according to the present invention, with a rotary blade body omitted; and

FIG. 3 is a plan view to show the assembled state of the air supercharger, according to the present invention.

### DESCRIPTION OF REFERENCE CHARACTERS OF IMPORTANT PARTS

100: housing 105: locking ring 110: inner circumference
113: locking surface 114: notch 120: support rib
123: guide surface 130: shaft support pipe 131: shaft hole
200: rotary blade body 210: blade support pipe 220: rotary blade
300: stationary blade body 310: support rim 313: elastic part
315: support protrusion 320: stationary blade

### BEST MODE FOR CARRYING OUT THE INVENTION

Hereinafter, the preferred embodiment of the present invention will be described in detail with reference to the accompanying drawings.

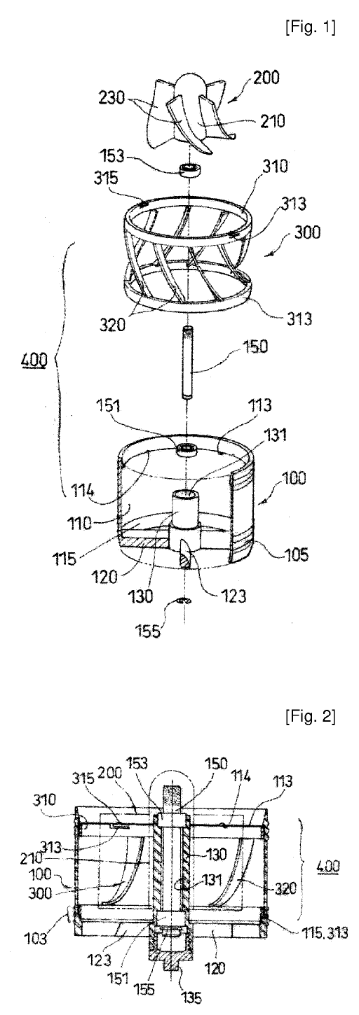

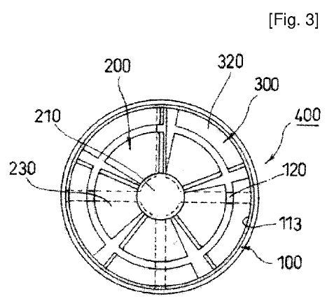

FIG. 1 is an exploded perspective view of an air supercharger, according to the present invention, FIG. 2 is a vertical sectional view to show the assembled state of the air supercharger, according to the present invention, with a rotary blade body omitted, and FIG. 3 is a plan view to show the assembled state of the air supercharger, according to the present invention.

An air supercharger 400 of the present invention includes a cylindrical housing 100 installed between an air cleaner and an intake manifold (not shown). Locking rings 105 are provided at upper and lower positions of the outer circumference of the housing 100, and reduce frictional force during assembly and increase contacting force after assembly.

Support ribs 120 extend from four sides of an inner circumference 110 of the housing 100 to a central position thereof in such a way as to form a single structure. When the support ribs 120 are formed, an inclined guide surface 123 is provided on a surface of each support rib 120.

A shaft support pipe 130 is provided at a central position of the support ribs 120 in such a way as to extend in an axial direction of the housing 100. A shaft hole 121 is formed on the central position of the shaft support pipe 130.

Further, a locking surface 113, comprising an inclined step, is provided on an upper end of the inner circumference of the housing 100. A stop surface 115 is provided on a lower end of the housing 100, and is inclined such that an inner diameter thereof is reduced in a direction from an upper end of the stop surface 115 to a lower end thereof. Particularly, concave notches 114 are formed at predetermined positions on the locking surface 113.

A rotating shaft 150 is inserted into the shaft hole 131 of the shaft support pipe 130 of the housing 100. The rotating shaft 150 is held by rolling frictional members 151 and 153 which are provided on lower and upper ends of the shaft hole 131. A ring washer 155 is fitted over the rotating shaft 150.

A stationary blade body 300, inserted into the inner circumference 110 of the housing 100, has a cylindrical shape. Stationary blades 330 are formed through a mechanical processing operation using a press or the like in such a way as to protrude inwards.

The protruding stationary blades 330 each have a helical shape, and retain curved surfaces.

Support rims 310 are provided on upper and lower ends of the stationary blade body 300 having the stationary blades 330. Further, in order to achieve the objects of the present invention, elastic parts 313 each having a support protrusion 315 are provided on the upper support rim 310.

A rotary blade body 200 mounted to the shaft support pipe 130 of the housing 100 is coupled to the rotating shaft 150, and a blade support pipe 210 for supporting rotary blades 230 has the same length as the shaft support pipe 130. Each of the rotary blades 230 has a helical shape, with a curved surface provided on each rotary blade.

Preferably, the guide surfaces 123 of the support ribs 120, the rotary blades 230, and the stationary blades 320 have the shape of a helix that is inclined in the same direction and have the curved surface.

In the air supercharger of this invention constructed as described above, the stationary blade body 300 is inserted into the inner circumference 110 of the cylindrical housing 100. At this time, the inclined locking surface 113 guides the insertion of the support rims 310 of the stationary blade body 300. While the stationary blade body 300 is inserted into the inner circumference 110, the inclined stop surface 115 comes into close contact with the lower support rim 310 of the stationary blade body 300, and the upper support rim 310 is locked by the step of the locking surface 113. When the stationary blade body 300 is assembled with the housing 100 such that the locking protrusions 315 protruding from the elastic parts 313 are fitted into the notches 114 which are provided on the locking surface 113, the locking protrusions 315 are seated in the notches 114 of the locking surface 113 due to the elasticity of the elastic parts 313. Thus, the stationary blade body 300 is stably maintained in the inner circumference 110 of the housing 100.

Next, the rotating shaft 150 is inserted into the shaft hole 131 of the shaft support pipe 130 of the housing 100. The rolling frictional members 151 and 153 are provided on the upper and lower ends of the rotating shaft 150 such that the rolling frictional members 151 and 153 are coupled to the shaft support pipe 130. Thereafter, the ring washer 155 is secured to the lower end of the rotating shaft 150.

In such a state, the upper end of the rotating shaft 150 is exposed to the outside of the upper end of the shaft support pipe 130, so that the rotary blade body 200 is mounted to the exposed upper end of the rotating shaft.

When the blade support pipe 210 of the rotary blade body 200 is coupled to the upper end of the rotating shaft, the blade support pipe 210 covers the shaft support pipe 130.

The air supercharger 400 assembled in this way is installed between the air cleaner and the intake manifold. In this case, the locking rings 105 provided on the outer circumference of the housing 100 serve to reduce a contact area, thus affording smooth insertion. Further, while the air supercharger 400 is inserted, the locking rings 105 concentratedly push the contact surfaces. Thus, the air supercharger 400 is stably held at an installed position.

According to the present invention, the stationary blades 320 of the stationary blade body 300 and the rotary blades 230 of the rotary blade body 200 have curved surfaces, which are inclined in the same direction. Thus, air passing through the air cleaner collides with the rotary blades 230 of the rotary blade body 20, so that the rotary blade body is rotated, and simultaneously vortices are created in the air due to the curved surfaces, like a conventional air supercharger or air swirling device.

During the flow of air swirled by the rotary blades 230, the air collides with the stationary blades 320 of the stationary blade body 300 which is mounted to the inner circumference 110 of the housing 100. At this time, the air is guided by the curved surfaces, thus accelerating the swirling air. It provides force for flowing air, as though the air supercharger were drawing external air.

Further, the guide surface 123 of each support rib 120, provided on the inner circumference 110 of the housing 100, is shaped to minimize resistance when the guide surface collides with swirling air. Thus, the guide surfaces 123 prevent the vortex of air generated on the inner circumference of the housing 100 from being reduced.

Consequently, the stationary blades 320 and the guide surfaces 123 serve to further push the swirling air into the intake manifold. It has the same operation as a sail which is hoisted for acceleration, when an unpowered ship is propelled by rowing.

### INDUSTRIAL APPLICABILITY

As described above, the present invention allows a stationary blade body to be stably installed in a housing, allows an air supercharger to be stably installed between an air cleaner and an intake manifold, and causes a stationary blade and a guide surface to be formed at the same angle and in the same direction as those of a blade of a rotary blade body, thus rapidly thrusting swirling air into a combustion chamber of an engine, therefore improving fuel economy, and affording easy assembly and maintenance.

1. An air supercharger for a vehicle engine, comprising:
a cylindrical housing installed between a manifold of the engine and an air cleaner;
support ribs to extend from four sides of an inner circumference of the housing to a central position of the housing in such a way as to form a single structure;
a shaft support pipe provided at a predetermined position on the support ribs, with a shaft hole being vertically formed in an axial direction of the housing;
a locking surface provided on an upper end of the inner circumference of the housing, and comprising an inclined step, with a concave notch being formed at a predetermined position on the locking surface;
a cylindrical stationary blade body inserted into the inner circumference of the housing, and held between the locking surface and a stop surface of the housing, the stationary blade body comprising:
support rims provided on upper and lower ends of the stationary blade body;
a stationary blade provided between the support rims, and comprising a helical surface curved in a direction of an inner circumference of the stationary blade body; and
an elastic part provided on the upper support rim and integrally provided with a locking protrusion;
a rotating shaft installed in the shaft support pipe, together with a rolling frictional member;
a rotary blade body inserted into the inner circumference of the stationary blade body, and coupled to the rotating shaft, the rotary blade body comprising:
a blade support pipe coupled to the rotating shaft, and covering the shaft support pipe; and
a rotary blade radially protruding from an outer surface of the blade support pipe, and having a helical curved surface; and
locking rings provided on upper and lower ends of an outer circumference of the housing, and maintaining a stably installed state.

2. The air supercharger according to claim 1, wherein the housing and the stationary blade body are formed through injection molding using synthetic resin so that the stationary blade body is integrally provided on the inner circumference of the housing.

3. The air supercharger according to claim 1, wherein helical surfaces of the rotary blade, the stationary blade, and the guide surface have the same direction.
